(19) United States
(12) Patent Application Publication
(10) Pub. No.: US 2012/0193192 A1
(43) Pub. Date: Aug. 2, 2012

(54) OVERHEAD CONVEYOR AND DRIVE CHAIN FOR THE OVERHEAD CONVEYOR

(76) Inventor: Max Winkler, Graz (AT)

(21) Appl. No.: 13/307,086

(22) Filed: Nov. 30, 2011

(30) Foreign Application Priority Data
Nov. 30, 2010 (DE) 10 2010 053 426.9

(51) Int. Cl. B65G 17/38; B65G 23/06

(52) U.S. Cl. 198/687; 198/834

(57) ABSTRACT

A drive chain of an overhead conveyor for transporting hanging articles. The drive chain comprises a plurality of traction rod elements connected by coupling elements. Each traction rod element comprises a base body extending substantially along a conveying direction and having a first longitudinal end and an opposite second longitudinal end, which respectively comprise a connection section into which a connection bolt is insertable. The base body comprises a frictional engagement section for interacting in a frictional-engaged manner with a drive wheel of a friction roller drive, which drive wheel is forced against the frictional engagement section to move the drive chain in the conveying direction. The base body further comprises a positive engagement section for interacting with spaced synchronization units to prevent displacement of neighbouring traction rod elements in the conveying direction by a positive engagement. The displacement is adjusted variably between the neighbouring traction rod elements.

### CROSS-REFERENCES TO RELATED APPLICATIONS

This application claims priority (Paris Convention) from German patent application DE 10 2010 053 426.9, filed on 30 Nov. 2010. The entire contents of this priority application is incorporated herein by reference.

### BACKGROUND OF THE INVENTION

The present invention relates to a drive chain of an overhead conveyor, the drive chain having a plurality of traction rod elements. The invention further relates to an overhead conveyor being equipped with such a drive chain. The drive chain is substantially driven by a friction roller drive, thereby moving in a conveying direction. Hanging articles such as garments are hooked into the traction rod elements by means of pockets or between neighbouring traction rod elements. Each of the traction rod elements can transport simultaneously one or more hanging articles.

### RELATED PRIOR ART

Conventional overhead conveyors, as exemplarily described in the European patent application EP 0 388 668 A1 and the German patent DE 34 24 426 C1, often comprise roller chains implementing the drive chain. The roller chain in turn comprises outer link plates and inner link plates which are bolted together. The bolts serve as bearings for sleeves, wherein shell-shaped rollers are sitting thereon. The inner link plates sit on the sleeves being designated as bushes which are located on the bolts. The outer link plates are sitting directly on the bolts. One roller is provided respectively on the sleeve between the inner link plates. This results in reduction of the driving forces and reduction of wear. Roller chains are often used with chain drives such as in combination with bicycles, motorcycles and also overhead conveyor drive chains. In this context, an embodiment having double members (Duplex chain) is often used due to the high load.

A Duplex chain is also used as a drive chain in the European patent EP 1 690 811 B1, wherein a second set of rollers and connecting link plates is omitted so that a protruding section of the bolts serves as a carrier. This carrier engage in a latch-like manner the upper sides of transport adapters.

Further, traction rod chains are known having chain members made of traction rod elements which are connected to each other by cardan joints being supported in a gimbled manner. Such traction rod elements comprise a longitudinal body having one or more pockets for receiving heads of hangers, wherein the body comprises at least one section having a plane surface and extending substantially along the longitudinal direction (conveying direction). A drive wheel of a friction roller drive can be pressed to this section, wherein a counterpressure wheel is oppositely arranged relative to the drive wheel. The counterpressure wheel is forced against a surface of the traction rod element which is also flat and located opposite to the surface against which the drive wheel is forced. The drive wheel and the counterpressure wheel clamp the traction rod elements therebetween. The flat surfaces are shaped such that the drive wheel and the counterpressure wheel do not need to be tracked perpendicular relative to the transportation direction as it would be the case if recesses are present in the surface, or do not need to dodge as would be the case if projections are present in the surface.

With known traction rod drive chains of the above-described type the drive is caused through a frictional engagement by forcing the wheel pair of the roller drives to the traction rod elements. The drive chain can have several hundred meters of length since greater distances, for example, between a storage location and a shipping location need to be bridged in a warehouse. Therefore, the drive chain is often driven by a plurality of friction roller drives. Roller drives which are neighbouring each other in the conveying direction are provided at distances of 40 m, for example. The distances can vary. In areas of positive inclination the drives can be positioned, for example, closer.

The (endless) drive chain passes positive and negative inclinations between substantially horizontal sections during one revolution. In this case the drive chain is pulled and/or pushed by the friction roller drives. A drive being arranged at the bottom of a positive inclination pushes the chain typically uphill, while another friction roller drive being arranged after an end of the positive inclination typically pulls the chain. If the chain is heavily loaded, i.e. carries a lot of garments, in the area of the positive inclination, the drive chain is squeezed together at the bottom area whereas the drive chain is stretched at an upper end of the positive inclination. Further, squeezing and stretching of the drive chain are also possible due to the universal joints being supported with a clearance between the traction rod elements.

In fact, situations can occur where the drives, which are arranged, for example, in the direct vicinity of the positive inclination, are not sufficient to move-on the chain in the conveying direction. The drives, i.e. the drive wheels, spin. Slippage occurs. The frictional engagement is lost until remotely arranged drives join-in assisting. At an upper end of the positive inclination the stretch of the chain is continued until sufficient drives, being located further downstream, pull the halting part of the chain, while at the bottom of the positive inclination other drives push which are located further upstream. By the time when sufficient drives move-on the drive chain in a frictional engaged manner, slippage is present at the concerned drives. This means that at certain points or sections transportation of the chain can stagnate although the entire system is operated at an average constant conveying velocity. This represents a problem in overhead conveyor systems performing path tracking of the traction rod elements in order to actuate, for example, switches or the like.

A path-dependent control having, for example, incremental counters exemplarily allows distinguishing and counting individual traction rod elements. Typically, an incremental counter is provided serving as a reference for the entire overhead conveyor. At the location of the incremental counter the number of traction rod elements of the drive chain being moved along the conveying direction is tracked. Due to the above-described possible problems this, however, does not necessarily mean that at each location along a transportation path of the overhead conveyor the transportation chain has been transported by the same path length along the conveying direction. In front of the above-described negative inclination there may be situations where the transport chain has been moved less further downstream. If a switch is sitting exactly at this location, which is to be actuated due to a predetermined advance of the entire drive chain, i.e. independent of a predetermined traction rod element, faulty operation might happen. A superordinated control allegedly takes the view that the switch is actuated at a predetermined one of the traction rod elements although this predetermined traction rod element has not yet arrived at the location of the switch. This is a great problem when controlling the entire system.

Certainly, the overhead conveyor can repeatedly be reset and restarted, for example, by means of an absolute reference point along the drive chain in a controlled manner, i.e. by means of software. But in practice it might happen that a software compensation device is not sufficient for determining exactly an actual displacement in position.

Wear of the traction rod chain is particularly problematic. The joints can wear in the area of the moving components, thereby causing a clearance between neighbouring traction rod elements. Therefore, in the course of the operation years it might be necessary to adjust the chain mechanically and correspondingly reset the control.

As long as a displacement in the entire system exists, a plurality of false controls might happen, in particular at feeding and discharging positions of so-called receiving and delivering stations. The control is actually supposed to “discharge” the traction rod having the number 4711, but actually discharges the traction rod having the number “4709”, because the drive chain is delayed in the area of the discharging station by the length of two traction elements.

Another problem is to be seen in the technical complexity of a receiving device, for example. A to-be-hung hanger needs to be hung in a predetermined pocket of a traction rod element. Often the traction rod elements comprise a number of pockets which are separated from each other by vertical webs. During the receipt of a hanger it is to be avoided that the hanger is transferred at the location of one of the vertical webs. Feeding lines are provided for this purpose, on which the to-be-hung hanger are accelerated to the same velocity like the traction rod chain. The feeding lines are respectively provided with their own drive, which preferably is velocity-controlled, in order to allow adaptation of the velocity of the traction rod chain. If slippage, which is not detectible at this location, happens in a handing over area between the feeding line and the traction rod chain the hanger is possibly received in a wrong pocket.

In order to hit a predetermined pocket safely, i.e. this pocket and no other pocket, the geometrical length thereof is selected sufficiently large. This is particularly relevant with sorting applications because in this case only one hanger is allowed at each pocket. However, for this reason receiving capacity of the chain is reduced.

### SUMMARY OF THE INVENTION

Therefore, it is an object of the present invention to provide a traction rod drive chain and an overhead conveyor which overcomes the problems of the prior art described above. In particular, the traction rod drive chain and overhead conveyor are to be provided, which are substantially driven by means of frictional engagement as achieved, for example, by a friction roller drive. In this case the control is preferably based on a path measurement (for example, number of traction rod elements moved downstream).

This object is solved by an drive chain of an overhead conveyor, the overhead conveyor transporting hanging articles, in particular garments, between remote locations, wherein the drive chain comprises a plurality of traction rod elements which are connected to each other by coupling elements, wherein each of the traction rod elements comprises a base body which substantially extends along a conveying direction and comprises a first longitudinal end and a second longitudinal end, which are arranged oppositely and respectively comprise a connection section into which a connection bolt can be inserted, wherein the base body comprises a frictional engagement section adapted to interact in a frictional engaged manner with a drive wheel of a friction roller drive of the overhead conveyor, which is forced against the frictional engagement section, in order to move the drive chain in the conveying direction; wherein the base body comprises additionally a positive engagement section adapted to interact with a number of synchronization units being arranged remotely from each other, which prevent displacement of neighbouring traction rod elements in the conveying direction by means of a positive engagement, wherein the displacement is set variably between neighbouring traction rod elements during a pushed and/or pulled movement of the drive chain.

The positive engagement section allows synchronization of the advance of the drive chain at an arbitrary location along the conveying path. During the first starting, if the drive chain rests, the overhead conveyor can be adjusted such that almost no compressed or extended drive chain areas are present over the entire length of the overhead conveyor. If in this situation the drive chain is moved down-stream, for example, by the length of one traction rod element, which is preferably in accordance with a standard with regard to the length thereof, along the conveying direction, preferably all of the remaining traction rod elements also move down-stream by one length. If a movement “downstream” is mentioned hereinafter, this means a movement in the conveying direction.

Despite the positive engagement sections, which are provided preferably at each of the traction rod elements, in particular essentially over the entire length in the conveying direction thereof, compressions and extensions of the drive chain between neighbouring synchronization units might occur, the synchronization units in turn interacting with these positive engagement sections. However, these compressions and extensions can be compensated at least at the location of the respective synchronization unit.

Individually driven feeding and/or discharging devices, which were formerly required for incorporating working stations such as receiving or delivering devices into the main stream of the overhead conveyor with a path-length dependent control of the entire system, become unnecessary by the invention.

The present invention effects that path-length dependently controlled overhead conveyors can be controlled, nevertheless, in a path-length dependent or advance-dependent manner in spite of a frictional engagement drive having slippage, which is desired for allowing compressions and extensions for the purpose of wear avoidance.

Preferably, neighbouring traction rod elements are respectively connected to each other by means of a universal joint, wherein each of the universal joints is suitable for continuously receiving one or more of the connection bolts.

The drive chain can be guided along curves without any problem by means of the universal joints. Typical curves have a radius which is, in dependence on the traction rod length, bigger than one individual traction rod by a factor of x. The universal joints are arranged in opposite connection sections of neighbouring traction rod elements, and are connected by means of one or more connection bolts to the base bodies of the traction rod elements. A universal joint, being formed in this manner, allows keeping the drive chain movable not only around curves but also at positive and negative inclinations or slopes. Cross-connection bolts typically orientated horizontally can be used additionally for sensorial distinguishing neighbouring traction rod elements. A cross-connection bolt can represent, for example, either the start or the end of one of the traction rod elements. A signal is always generated if the drive chain passes a corresponding (statically mounted) sensor, the signal signalling to a superordinated control that a new traction rod element will pass the sensor subsequently. The traction rod elements of the chain can be counted continuously in this manner. The count can be taken as a basis for a path-dependent control. For this purpose, information on the relevant working stations such as the locations of switches, feeding stations, delivery stations etc. can be stored in the control. Preferably, distances between the working stations and an absolute reference point (for example, the location of an initial sensor) are recorded for this purpose.

According to a specific embodiment the positive engagement section comprises a gear-rack profile which is provided at least at one side of the base body, which in particular is formed thereto, and preferably interacts with at least one gear, (or one caterpillar drive) of the synchronization unit in a positive engaged manner over a length of the base body.

By means of the gear-rack profile a positive engagement is ensured along the entire length of the base body of the traction rod element. As soon as one traction rod element passes the synchronization unit, the positive engagement is present between the traction rod element and the synchronization unit during the entire passage. This ensures that a possible slippage of the drive chain can be detected at any time, provided that the gear comprises a corresponding measurement device. The synchronization unit can be connected to the superordinated control for this purpose. For example, the number of revolutions of the gear can be counted in increments, but also absolutely. The superordinated control gets signalled an information in terms of a measuring value, from which information a conveying velocity can be derived at the location of the synchronization unit. This applies to both forward as well as rearward movements of the drive chain. The slippage, where the drive chain does not move, can be detected as well although the friction roller drive move.

With a particular embodiment the positive engagement section comprises a profile of holes which interacts in a positive engaged manner with elements of the synchronization unit having pins.

As an alternative, or in addition, to the gear-rack profile a positive engagement between the traction rod elements and the synchronization unit can be achieved in this manner. Although the gear-rack profiles typically interact with the drive chain in a horizontal plane, the profile of holes can also interact with the element of the synchronization unit having pins in a perpendicular plane. Thus, designers of conveyor systems can decide freely on the orientation of the synchronization unit relative to the drive chain. In many cases insufficient construction space for arranging the synchronization unit and the drive chain horizontally is present. In these cases, one can switch to the vertical orientation. This applies also for the inverted case.

Further, it is preferred if a counterpressure wheel of the friction roller drive is coated with Vulkollan or any similar material, wherein the drive wheel of the friction roller drive preferably is coated with Vulkollan as well.

Vulkollan is one of the most powerful elastomers in the market. Vulkollan has extraordinary mechanical and dynamical material characteristics. It can be submitted to the highest mechanical loads, and comprises a very high dynamic bearing capacity. Vulkollan is a registered trademark of the Bayer Company. Vulkollan has a high friction value so that the slippage between the drive chain and the friction rollers of the chain drive is reduced.

With another advantageous embodiment each of the traction rod elements is an integral injection-moulded part, and preferably comprises one or more transportation pockets. Alternatively, the traction rod can also be a die-casted metal piece or welded steel.

The traction rod element can be manufactured cheaply due to the integral formation of the base body. If the base body comprises pockets, the traction rod element can be used within a drive chain of an overhead conveyor having a sorting function. During the sorting process of hanging goods it is necessary to allow at any time a safe statement on a location of predetermined hanging goods on the drive chain. Otherwise the sorting process cannot be conducted. During the sorting process the hanging goods are arranged in accordance with a predetermined sequence by inserting the hanging goods in a first step into the endlessly rotating drive chain, and in a second step charging same at a predetermined destination, wherein a plurality of destinations are typically present. In this case, delivery needs to be accurate in position.

The above-mentioned object is also solved by an overhead conveyor comprising: at least one drive unit; at least one synchronization unit; a drive chain in accordance with the invention; and preferably a guide rail in which the drive chain runs.

Preferably, each of the synchronization units comprises a synchronizing element which forms with the positive engagement section a positive engagement such that neighbouring traction rod elements keep a predetermined distance relative to each other in the conveying direction.

For this purpose, the synchronizing element can be driven preferably at the same velocity like the friction roller drive. If a predetermined traction rod element arrives at the location of one of the synchronization units within an admissible tolerance (path difference) and if the synchronization unit is arranged immediately upstream relative to a working station, the control can operate the subsequent working station accurate in position. In this case, it is not necessary to check again whether an actual traction rod element corresponds to a required traction rod element at the location of the working station. A number of sensors required for verifying the advance along the conveying path can be reduced significantly in this manner. Empty buffer locations, i.e. sections on the drive chain which are (on purpose) not loaded with hanging goods, can be reduced in this manner. However, the superordinated control can be sure that, for example, a group of garments is actually present within a predetermined section of the drive chain, i.e. is inserted and is not distributed over more traction rod elements than initially planned.

With an advantageous embodiment the overhead conveyor system comprises a reference point measurement device.

Marking elements such as the above-mentioned transverse connection bolt can be detected by means of the reference point measurement device for each of the traction rod elements, and can be counted in particular. The marking elements are arranged at regular distances between neighbouring traction rod elements. Each of the traction rod elements comprises (per pocket) at least one marking element. It is clear that one traction rod element can also be equipped with a number of the marking elements, which preferably have regularly arranged distances in this case. Several of the marking elements are reasonable, for example, in cases where the traction rod elements respectively comprise a number of pockets and each of the pockets is intended to receive one single good. In this case, the superordinated control can identify the respective pockets by means of the marking elements.

With another preferred embodiment the overhead conveyor system comprises at least one station for receiving and/or delivering hanging goods from and to one of the traction rod elements of the drive chain, wherein preferably each of the stations has assigned at least one of the synchronization units being arranged in the area of the station.

Synchronization is often a problem with both, the receipt and the delivery of hanging articles, for example, with the usage of traction rod elements having pockets formed thereto. Vertical webs of these pockets disturb the receipt and delivery because no hanging goods can be located at the webs. If a hanging good is inserted (receipt) exactly at the location of one of the vertical webs disturbances are the result. If one hanging good is discharged (delivery) exactly at the location of one of the vertical webs, disturbances are the result because in both cases the vertical web is in the way. In this case the hanging goods are neither inserted nor discharged. Thus, faults happen.

It is preferred in particular, that the assigned synchronization unit is coupled to the drive chain of the overhead conveyor such that a station-drive chain is driven at the same conveying velocity like the drive chain.

Stations-drive units, like they are typically used with conventional working stations for operating a feeding line or discharging line of the station at the same velocity like the main conveying line being represented by the drive chain, can be omitted simply. The traction rod drive chain of the present invention drives the station-drive chains in this case. Thus, fewer elements are required so that the overhead conveyor system of the present invention is cheaper and requires less maintenance.

It is clear that the above-mentioned and hereinafter still to be explained features cannot only be applied in the respectively given combination but also in other combinations or alone without departing from the spirit and scope of the present invention.

### BRIEF DESCRIPTION OF THE DRAWINGS

Embodiments of the invention are illustrated in the drawings and will be explained hereinafter in more detail, wherein:

FIGS. 1A-E show different views of a first embodiment of a traction rod element of the invention;

FIG. 2 shows a perspective view of a conventional traction rod drive chain;

FIG. 3 shows an overhead conveyer system in accordance with the invention; and

FIG. 4 shows a detail of another overhead conveyer system in accordance with the invention.

### DESCRIPTION OF PREFERRED EMBODIMENTS

In the following description of the invention identical parts and features will be designated with the identical reference numerals, wherein the disclosure contained in the entire description can be transferred in the same sense on identical parts and features having the same reference numerals. Positional statements such as “over”, “under”, “laterally” etc. apply to the immediately described figure, but can be transferred in the same sense to a new position, if the position is to be changed.

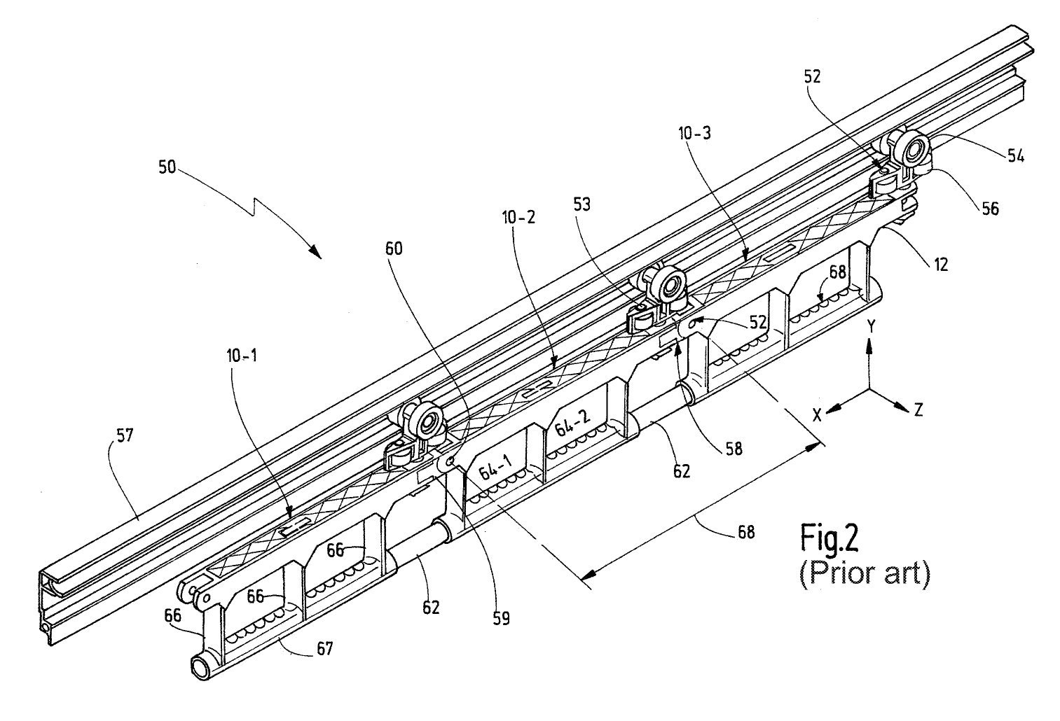

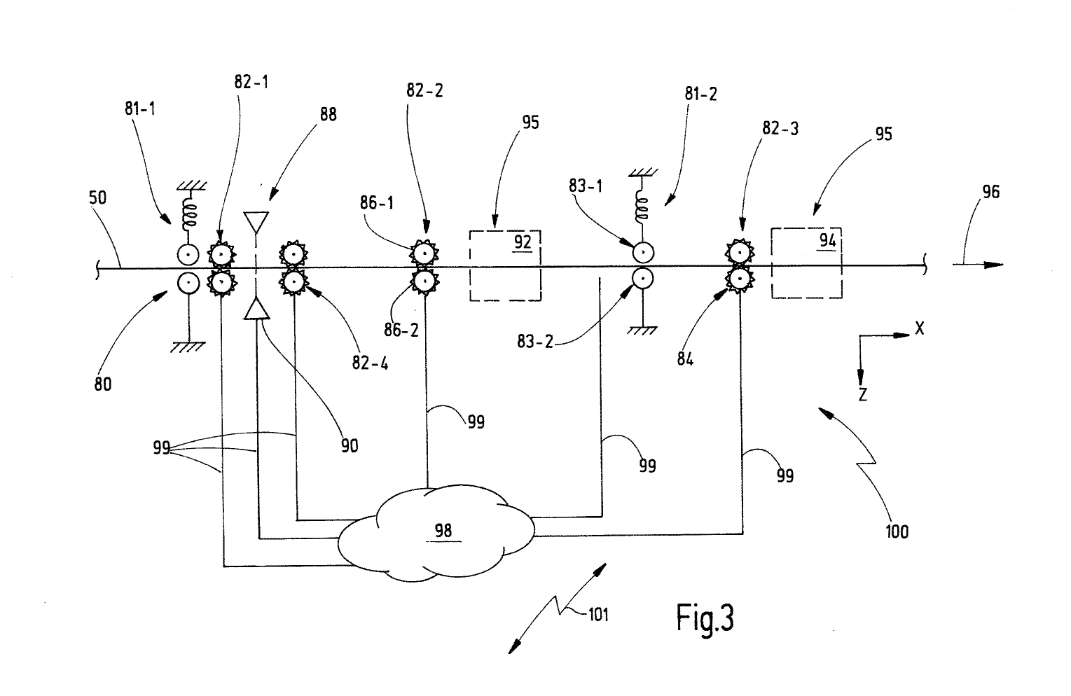

In the following description a traction rod element (which is also designated “traction rod” hereinafter) in accordance with the invention is always designated with the reference numeral 10, independent of the embodiment. The traction rod 10 is a chain member of an overhead conveyor 100 such as the one exemplarily shown in FIG. 3. FIG. 2 shows a conventional drive chain 50 (which is also designated “chain” hereinafter) but which can be modified in terms of the invention. One principle provision of the invention is that the drive chain 50 is driven substantially by one or more friction roller drives 81, as described with reference to FIG. 3 in more detail. A friction roller drive 81 represents one possible embodiment of a drive by means of frictional engagement.

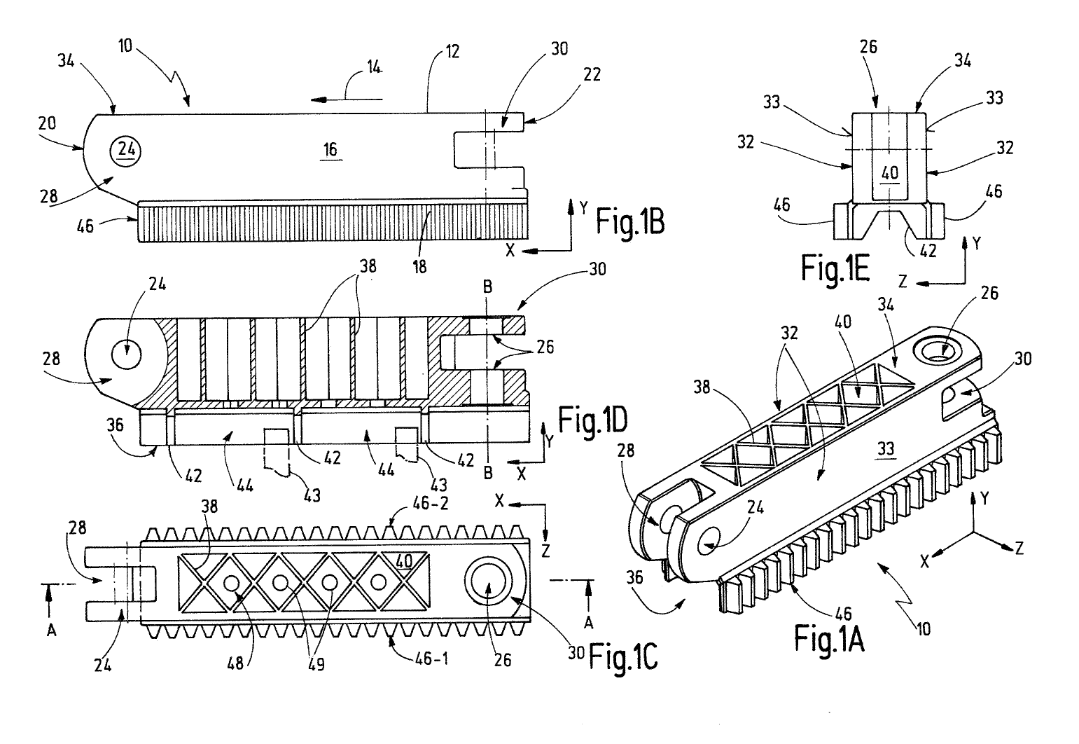

FIG. 1A shows a perspective view of a first embodiment of a traction rod 10 in accordance with the invention. FIG. 1B shows a side view. FIG. 1C shows a top view. FIG. 1D shows a section along a line A-A in FIG. 1C. FIG. 1E shows a section along line B-B of FIG. 1D. In the following, the FIGS. 1A through 1E are referred to in common.

The traction rod 10 comprises a base body 12 which extends substantially along a longitudinal direction 14. The longitudinal direction 14 is orientated, for example, parallel to the direction X. The base body 12 comprises a frictional engagement section 16 and a positive engagement section 18 which might be adjacent to each other. The frictional engagement section 16 substantially extends in the longitudinal direction 14. Similar does the positive engagement section 18.

The base body 12 comprises a first longitudinal end 20 and a second longitudinal end 22. The first longitudinal end 20 can be provided with a first (horizontal) opening 24. The second longitudinal end 22 can be provided with a second (vertical) opening 26. The first and second longitudinal ends 20 and 22 define connection sections 28 and 30 with the first opening 24 and the second opening 26. The connection sections 28 and 30 serve for connecting neighbouring traction rods 10, as it will be explained with reference to FIG. 2 in more detail. The orientation of the openings 24 and 26 is preferably selected so that a universal joint can be formed such that the chain 50 can be guided without problems through curves, positive and/or negative inclinations. It is clear that a relative position of the connection sections 28 and 30 can be changed. The orientation of the openings 24 and 26 can be exchanged or modified. The openings 24 and 26 can be orientated in the same sense.

The connection section 28 preferably comprises one vertical slot for receiving a coupling element (joint). The connection section 30 preferably comprises a horizontal slot for receiving a coupling element. The slots in the connection elements 28 and 30 are preferably formed such that the coupling element is supported pivotally. The openings 24 and 26 serve for receiving bolts, on which bolts the coupling elements can be supported. In dependence on the shape of the bolts the shape of the openings 24 and 26 is selected. In the present case, the openings 24 exemplarily comprise a circular cross section as exemplarily depicted in the FIGS. 1B, 1C and 1D for the connection sections 28 and 30.

FIG. 1A clearly shows that the frictional engagement section 16 is arranged along two lateral longitudinal sides 32 having surfaces 33 which are preferably smooth and flat. The lateral longitudinal sides 32 extend over an entire length of the base body 12 in the longitudinal direction 14. The longitudinal sides are orientated (vertical) parallel to each other. It is clear that the lateral longitudinal sides 32 can also be arranged at an angle. The lateral longitudinal sides 32 extend in a vertical direction (direction Y) almost over the entire base body 12, with the exception of the positive engagement section 18. The lateral longitudinal sides 32 define a substantially ashlar-shaped base body 12 together with a (horizontal) top side 34 and bottom 36. However, the base body 12 can also have a different geometry.

Reinforcement ribs 38 can be arranged between the lateral longitudinal sides 32 in a cross-shaped configuration within an interior 40. The interior 40 reduces an amount of material required for manufacturing the traction rods 10. The reinforcement ribs 38 serve for stiffening the base body 12 in a transverse direction (direction Z). Friction rollers 83, which are not shown in FIG. 1, of a friction roller drive 81 are forced against the surfaces 33 of the longitudinal sides 32 so that frictional engagement between the (not shown) rollers 83 of the friction roller drive 81 and the base body 12 of the traction rod 10 is achieved. For this purpose, the rollers 83 are forced preferably perpendicularly relative to the surfaces 33 onto the longitudinal sides 32 by means of a sufficient force.

The interior 40 preferably does not extend over the entire height (direction Y) of the base body 12. With the embodiment of the traction rod 10 of FIG. 1 the interior 40 extends almost over two thirds of the height and substantially over the entire length of the base body, if the connection sections 28 and 30 are not taken into account. Beneath the interior 40 (cf. FIG. 1D) follower webs 42 can be arranged at regular distances preferably in the longitudinal direction, substantially extending in the vertical plane (plane YZ). The follower webs 42 serve for taking along, for example, slide adapters 43, partially indicated in FIG. 1D by means of dashed lines. Two neighbouring follower webs 42 define a chamber 44 therebetween which is adapted for receiving preferably one single slide adapter 43 which is described in the German patent application DE 10 2010 045 725 filed on Sep. 8, 2010, which application is incorporated by reference.

The chambers 44 preferably are equally long. This also applies if a number of traction rod elements 10 are connected to each other through coupling elements in the connection sections 28 and 30. In this case the last follower web 42 defines a lateral limitation of a chamber 44, which bridges two traction rods, and a first follower web 42 of the traction rod 10, which follows directly in an upstream direction, defines an opposite additional lateral limitation of the chamber 44 bridging the two traction rods.

The bottom 36 of the traction rod 10 can be opened downwardly so that the slide adapter 43 can be inserted from below into the chamber 44. The follower webs 42 do not need to extend flatly in the plane YZ for this purpose. The follower webs 42 can comprise recesses, as exemplarily indicated in FIG. 1E. The trapezoidal-shaped recess in the follower web 42 of FIG. 1E allows a certain clearance for the slide adapters 43 until they are engaging or disengaging with the traction rod 10. The width (direction Z) of the trapezoidal-shaped opening is increasing downwardly so that the slide adapter 43, in dependence on the respective width in the direction Z, can be disengaged from the follower web 42 before the slide adapter emerges completely from the chamber 44 in the direction Y. Conversely, the same applies to the engagement procedure of one of the slide adapters 43. The shape of the recess in the follower web 42 is selectable freely.

The positive engagement section 18 (cf. FIG. 1B), which is provided additionally to the frictional engagement section 16, can be achieved by a gear-rack profile 46. In this case, the gear-rack profile 46 joins the frictional engagement section 16 from below. The positive engagement section 18 substantially extends in the longitudinal direction 14. The gear-rack profile 46 extends along both sides 32 of the base body 12 of the traction rod 10 of FIG. 1.

The positive engagement section 18 serves for synchronizing conveying velocities as it will be explained in more detail below. The positive engagement section 18 can interact in a positive engaged manner with correspondingly formed synchronizing elements 84 of the synchronization units 82 (cf. FIG. 3), as will be described in more detail below as well. The gear-rack profile 46 is advantageous because, for example, gear wheels 86 can be used as the synchronizing elements 84, the gear wheels rotating about a vertical axis (axis Y) in the horizontal plane (plane XZ). It is clear that the orientation of the gear wheels 86 is dependent on the orientation of the traction rod 10 at the respective place of action. Then, the gear wheels 86 are correspondingly inclined in the negative or positive inclinations of the chain 50.

A profile 48 of holes 49 can be provided as the positive engagement section 18, alternatively or additionally. In FIG. 1 the holes 49 are provided in an intermediate base separating the interior 40 from the chambers 44. The holes 49 are preferably distanced regularly to each other and arranged along the longitudinal direction 14. The holes 49 extend vertically through the intermediate base and can interact, for example, with a pin-equipped wheel in a positive engaged manner, the wheel entering the chambers 44 from below and engaging into the holes 49. In order to provide sufficient space for such a pin-equipped wheel the recesses are provided in the follower webs 42 (cf. FIG. 1E).

It is clear that the positive engagement section 18 can also be realized in a different manner. The illustrated gear-rack profile 46 and the profile 48 of holes 49 are merely of an exemplary nature. The positive engagement section 18 can be provided at all of the sides of the base body 12, and also within the base body 12, and extends typically in the longitudinal direction 14, for detecting, assisting and/or synchronizing the transportation movement of the chain 50 comprising the traction rod elements 10. While the transportation movement is detected, the elements 84 interacting with the positive engagement section 18 are connected to path length measuring sensors (e.g. rotary encoder or the like). While assisting the drive of the chain 50, these elements 84 are connected to their own drive. During the synchronization these elements 84 are either connected directly or via additional members (e.g. gears), which transmit force, to other conveyor line components, which do not belong to the main conveyor line, but are to be moved at the same velocity.

FIG. 2 shows a perspective view of a conventional drive chain 50 which is made of traction rod elements 10 without positive engagement sections 18. It is clear that the traction rod elements 10 of the drive chain 50 of FIG. 2 can also be provided with one or more positive engagement sections 18. In this case it is clear that a conventional chain can simply be exchanged by chains of the invention, or the positive engaged unit is mounted as a separate piece later (retrofit/adaptation).

FIG. 2 shows exemplarily three traction rod elements 10-1 through 10-3 which are connected to each other by means of connection bolts 52 through one coupling element 58 such as universal joint 59. Each of the universal joints 59 comprises two recesses, corresponding to the first and second openings 22 and 24, for receiving a longitudinal connection bolt 53 and a transverse connection bolt 52 in a rotationally-supported manner. Idlers 54 are respectively supported in a rotatable manner by the longitudinal connection bolt 53, the idlers allowing movement of the drive chain 50 within a guide rail 57. The movement is predetermined by the guide rail 57. The weight of the drive chain 50 rests on the idlers 54 which are running on a horizontally orientated running surface in the guide rail 57. The guide rollers 56 cause a lateral guidance of the drive chain 50 in the guide rail 57, which is only partially illustrated in FIG. 2. The guide rail 57 can be integral or comprise a number of pieces. In FIG. 2 the guide rail 57 is formed in two pieces, wherein the left piece of the guide rail 57 is illustrated only. A right-hand piece of the guide rail 57 is then orientated in mirror symmetry relative to the depicted left-hand piece of the guide rail 57.

Highly stable slide bearings can be used in the openings 24 and 26 as well as in the openings for the universal joint.

Each of the traction rods 10-1 through 10-3 can be connected to the respectively immediately adjoining neighbour through a connection bar 62 which is inserted removable. The traction rod 10 of FIG. 2 additionally differs from the traction rod 10 of FIG. 1 in that one or more transportation pockets 64, instead of the chambers 44 of FIG. 1, are provided, which are defined by vertical pocket webs 66 and horizontal support shafts 67. In FIG. 2 each of the traction rods 10 comprises two equally sized transportation pockets 64-1 and 64-2. Preferably, interstice 66 between neighbouring traction rod elements 10 is substantially as large as one of the trans-portation pockets 64-1 and 64-2. The horizontally orientated transverse connection bolts 60 comprise a regular distance 68 (e.g. 25 cm) relative to each other and define, in terms of control, start and an end of the traction rod 10. The transverse connection bolts 60 are preferably made of metal in order to allow interaction with sensors detecting passage of the transverse connection bolts 60 if the drive chain 50 is moved. Such sensor systems have a drawback in that often no signal is detected in case of slippage, although one transverse connection bolt 60 has passed the corresponding sensor. It is clear that also other elements of the traction rod elements 10 can serve as counting reference. The pocket webs 66 can be detected, for example, by means of light barriers. The sensor can comprise several parts. In this manner, for example, 5 sensors can be arranged regularly in a sequence. With a corresponding distance of 5 cm between the sensors a traction rod 10 of a length of 25 cm can be resolved in steps of 5 cm, thereby increasing the accuracy of the path-dependent control.

It is clear that the traction rod elements 10-1 through 10-3 of FIG. 2 can also be provided with the positive engagement sections 18. The positive engagement sections 18 can be arranged, for example, in the area of the frictional engagement sections 16, i.e. in the upper area of the pockets 64, wherein sufficient space is to be kept for the frictional engagement section. The arrangement of the positive engagement sections 18 in the upper area of the traction rod elements 10 provides the advantage in that the positive engagement sections 18 cannot collide with the hanging goods, which are transported in the pockets 64 hanging down vertically.

With reference to FIG. 3 an overhead conveyor system 100 in accordance with the invention is shown.

The overhead conveyor system 100 comprises a drive chain 50, which is equipped, for example, with the traction rod elements 10 of FIG. 1. The chain 50 is moved by means of a main drive 80 in the conveying direction 96. The main drive 80 can comprise one or more friction roller drives 81. As an alternative to the friction roller drives 81 other drives can be provided which drive the chain 50 also by means of frictional engagement. In FIG. 3, for example, two friction roller drives 81-1 and 81-2 are shown which are arranged, for example, thirty to forty meters remote from each other.

Each of the friction roller drives 81 comprises a driven friction roller 83-2 and preferably one counter roller 83-1 (which is not driven). The counter rollers 83-1 can be forced against the chain 50 in a force-assisted manner, as indicated exemplarily with regard to the roller 83-1 by means of a biased spring.

Further, the overhead conveyor 100 comprises one or more synchronization units 82 which are arranged preferably in the immediate vicinity of points which are relevant in terms of control (e.g. working stations or switches) along the chain 50. In FIG. 3, for example, four synchronization units 82-1 through 82-4 are shown. Each of the synchronization units 82 comprises one or more synchronizing elements 84, presently in terms of gear wheels 86-1 and 86-2. The first synchronization unit 82-1 is arranged subsequently to the first friction roller drive 81-1. A second synchronization unit 82-2 is arranged upstream relative to the working station 95, which is presently formed as a receiving station 92. A third synchronization unit 82-3 is arranged immediately upstream relative to a delivery station 94. A fourth synchronization unit 82-4 follows the first synchronization unit 82-1 with in short distance. The distance between the two synchronization units 82-1 and 82-4 is selected so that a reference point measurement device 88 can be arranged therebetween. The reference point measurement device 88 can be implemented, as mentioned above, in terms of a sensor 90 scanning the transverse connection bolt 60 either electromagnetically or scanning (e.g. in terms of a light barrier) the pocket webs 66 optically. The synchronization units 82-1 and 82-4 prevent the chain 50 in the area of the reference point measurement device 88 from undetected slippage. For this purpose, the synchronization units 82 and the reference point measurement device 88 can be connected to a superordinated control 98 either via a solid wiring 99 (e.g. Ethernet bus) or wireless 101 (e.g. Wireless LAN).

The synchronization units 82 can be driven for maintaining, in an assisting manner, an average conveying velocity of the chain 50. However, the synchronization units 82 can also only supply signals which represent an advance of the chain 50 at the location of the respective one of the synchronization units 82. In this case the synchronization units 82 are used as measuring points for controlling pathdependently the working stations 95 which can be also implemented as switches or the like. With other words, this means that the working stations 95 can be operated such that predetermined ones of the traction rod elements 10 can be actuated in a position accurate manner. The traction rod carrying the number “4711” takes, for example, at the receiving station 92 a hanging good or item in the last pocket 64 thereof.

In order to keep this displacement of the chain 50 in the area of the working station 95, as indicated in FIG. 3 by means of broke lines, as small as possible it is recommended to provide directly in front of or subsequent to each of the stations an individual synchronization unit 82.

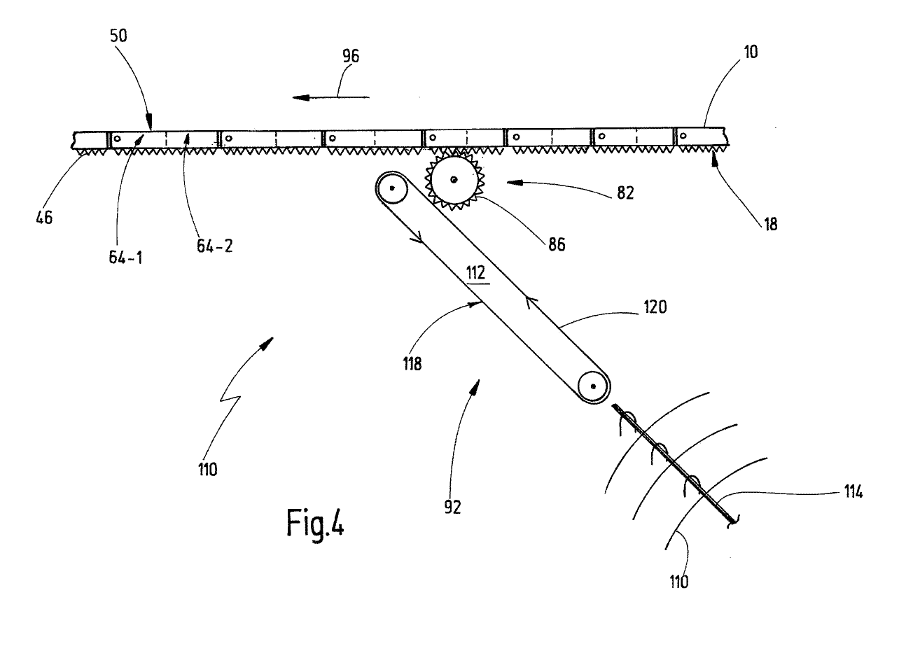

The synchronization unit 82, however, also has another function. The synchronization unit 82 can be used, as it will be explained in the context of FIG. 4 in greater detail, for synchronizing supply (feeding) and/or discharge lines of the working stations 95, which are respectively provided with their own trans-portation chain with regard to the transportation velocity of the drive chain 50 at the location of a respective one of the working stations 95. These velocities can be different over the entire length of the chain 50. The transportation chains of the supply and discharge lines, in this case, are not driven directly but are driven in an assisting manner by the synchronizing elements 84 of the synchronization units 82.

FIG. 4 shows a top view of a part of a sorter 110. The traction rod drive chain 50 is depicted only partially and moves in the conveying direction 96, i.e. from the right to the left in FIG. 4. In this case each of the traction rod elements 10 exemplarily comprises two pockets 64-1 and 64-2. If the traction rod drive chain 50 is used with a sorter 110, always only one single hanging item is transported in one pocket 64. Inserting hanging items into the chain 50 requires an arrangement of one or more receiving stations 82 in the immediate vicinity of the chain 50. Each of the receiving stations 82 is provided with a supply line 112, which in turn can be adjacent to a rail 114 providing hangers or hooks 116 where the hanging items hang. Separation devices are not shown which effect delivery of the hangers 116 from the rail 114 to the supply line 112.

The supply line 112 of the receiving station 92 comprises a station-drive chain 118 having a strand 120 endlessly revolving around idle pulleys.

In the area of the receiving station 92, preferably immediately upstream thereto, one synchronization unit 82 having a gear wheel 86 is provided as synchronizing element 84, which mesh with the gear-rack profile 46 of the positive engagement sections 18, which are provided in FIG. 4 only at one side of the traction rod elements 110. The gear wheel 86 meshes additionally with the strand 120 for driving the station-drive chain 118 at the same velocity by which velocity the chain 50 is moved in the area of the receiving station 92. It is clear that the gear wheel 86 can also be coupled to the strand 120 at a transmission gear ratio.

The receiving station 92 does not require a drive on its own for moving the station-drive chain 118. The movement of the station-drive chain 118 is synchronized to the movement of the drive chain 50. Even if slippage at the drive chain 50 happens in certain areas, the station-drive chain 118 is moved in a synchronized manner thereto. Even if the velocity of the chain 50 heavily varies, i.e. is not constant over longer periods of time, the station-drive chain 118 is moved in a synchronized manner. Hangers are handed over in a point-accurate manner.

It is clear that the same applies to the receiving station 94 or any other type of working station 95.

Another advantage of this (direct) synchronization of the different drive chains 50 and 118 is that less empty buffer traction rod elements 10 need to be provided between groups of hangers 116 belonging together (in terms of logistics), on the chain 50. The chain 50 can also be operated at a higher velocity.

Another advantage is to be seen in that receipt or delivery at the location of a pocket web 66 (cf. FIG. 2) is omitted with the path-dependent control of the entire system.

What is claimed is:

1. A drive chain for usage in an overhead conveyor, the overhead conveyor being adapted to transport hanging articles between remote locations in a conveying direction, the overhead conveyor comprising at least one friction roller drive, each of which includes a drive wheel, and at least one synchronization unit respectively comprising at least one gear wheel, the drive chain comprising:
a plurality of traction rod elements, wherein each of the traction rod elements comprises a base body extending substantially along the conveying direction and has a first longitudinal end and a second longitudinal end, which are arranged oppositely, wherein each of the base bodies comprises a connection section;
a plurality of coupling elements connecting the traction rod elements;
wherein each of the base bodies further comprises a frictional engagement section being adapted to interact in a frictional-engaged manner with the drive wheel of the at least one friction roller drive of the overhead conveyor, which drive wheel is forced against the frictional engagement section in order to move the drive chain in the conveying direction;
wherein each of the base bodies even further comprises a positive engagement section being adapted to interact with the number of synchronization units, which prevent displacement of neighbouring ones of the traction rod elements in the conveying direction by means of a positive engagement, wherein the displacement is adjusted variably between the neighbouring ones of the traction rod element during one of a pushed and pulled movement of the drive chain.

2. The drive chain of claim 1, wherein the traction rod elements are respectively connected to each other by means of a universal joint, wherein each of the universal joints is adapted to continuously receive one or more connection bolts.

3. The drive chain of claim 1, wherein the positive engagement section comprises a gear-rack profile being provided at least at one side of the respective base body,

4. The drive chain of claim 3, wherein the gear-rack profile is configured to interact with the at least one gear wheel of the at least one synchronization unit in a positive engaged manner over an entire length of the base body.

5. The drive chain of claim 1, wherein the positive engagement section comprises an arrangement of holes, which holes interact with pin-equipped elements of the at least one synchronization unit in a positive engaged manner.

6. The drive chain of claim 1, wherein each of the traction rod elements is an integrally injection-moulded part.

7. The drive chain of claim 6, wherein the integrally injection-moulded part comprises at least one transportation pocket.

8. An overhead conveyor for transporting hanging articles between remote locations in a conveying direction comprising:
at least one friction roller drive, each of which includes at least one drive wheel;
at least one synchronization unit, the synchronization units being distanced relative to each other and respectively comprise at least one gear wheel; and
one drive chain comprising: a plurality of traction rod elements, wherein each of the traction rod elements comprises a base body extending substantially along the conveying direction and has a first longitudinal end and a second longitudinal end, which are arranged oppositely, wherein each of the base bodies comprises a connection section; a plurality of coupling elements connected the traction rod elements; a plurality of connection bolts which is inserted into the connection sections; wherein the base body further comprises a frictional engagement section being adapted to interact in a frictional-engaged manner with the at least one drive wheel of the friction roller drive of the overhead conveyor, which drive wheel is forced against the frictional engagement section in order to move the drive chain in the conveying direction, wherein the base body even further comprises a positive engagement section being adapted to interact with the number of synchronization units, which prevent displacement of neighbouring ones of the traction rod elements in the conveying direction by means of a positive engagement, whereby the displacement is adjusted variably between the neighbouring ones of the traction rod elements during one of a pushed and pulled movement of the drive chain.

9. The overhead conveyor of claim 8 further comprising a guide rail, in which guide rail the drive chain is running.

10. The overhead conveyor of claim 8, wherein the at least one friction roller drive comprises a counter pressure wheel being coated with Vulkollan for interacting with the drive wheel.

11. The overhead conveyor of claim 10, wherein the drive wheel of the at least one friction roller device is coated with Vulkollan.

12. The overhead conveyor of claim 8, wherein each of the synchronization units comprises a synchronizing element forming a positive engagement with the positive engagement section such that the neighbouring ones of the traction rod elements maintain a predetermined distance to each other in the conveying direction.

13. The overhead conveyor system claim 8 further comprising a reference point measurement device adapted to detect marking elements which are arranged between the traction rod elements.

14. The overhead conveyor of claim 8 further comprising at least one station for supplying and delivering the hanging articles to and from one of the traction rod elements of the drive chain.

15. The overhead conveyor of claim 14, wherein each of the stations has assigned at least one of the synchronization units which are arranged in the area of the respective station.

16. The overhead conveyor system of claim 15, wherein each of the assigned synchronization units is coupled to the drive chain so that a station-drive chain is driven at a same velocity like the drive chain.
